(19) United States
(12) Patent Application Publication
(10) Pub. No.: US 2021/0182686 A1
(43) Pub. Date: Jun. 17, 2021

(54) CROSS-BATCH MEMORY FOR EMBEDDING LEARNING

(71) Applicant: Shenzhen Malong Technologies Co., Ltd., Shenzhen City (CN)

(72) Inventors: Xun WANG, Shenzhen (CN); Haozhi ZHANG, Shenzhen (CN); Weilin HUANG, Shenzhen (CN); Matthew Robert SCOTT, Shenzhen (CN)

(21) Appl. No.: 16/910,083

(22) Filed: Jun. 24, 2020

Related U.S. Application Data
(60) Provisional application No. 62/948,194, filed on Dec. 13, 2019.

(51) Int. Cl. G06N 3/08; G06K 9/62

(52) U.S. Cl. CPC G06N 3/084; G06K 9/628; G06K 9/6228; G06K 9/6215

(57) ABSTRACT

This disclosure includes computer vision technologies, specifically for embeddings and metric learning. In various practical applications, such as product recognition, image retrieval, face recognition, etc., the disclosed technologies use a cross-batch memory mechanism to memorize prior embeddings, so that a pair-based learning model can mine more pairs across multiple mini-batches or even over the whole dataset. The disclosed technologies not only boost the performance for various applications, but considerably improve the computation itself with its memory-efficient approach.

### CROSS-REFERENCE TO RELATED APPLICATIONS

This application claims the benefit of U.S. Provisional Application No. 62/948,194, filed Dec. 13, 2019, entitled “Cross-Batch Memory For Embedding Learning,” the benefit of priority of which is hereby claimed, and which is incorporated by reference herein in its entirety.

### BACKGROUND

Computer vision (CV) is a field for computers to gain a high-level understanding of digital images or videos. Image retrieval is a field for browsing, searching, and retrieving images from a database of digital images. Content-based image retrieval (CBIR), also known as query by image content (QBIC), is an application of CV techniques to the image retrieval problem. Different from traditional concept-based approaches (e.g., keywords, tags, or descriptions of an image), CBIR retrieves images based on similarities in their contents (e.g., textures, colors, shapes, etc.) based on a user-supplied query image or user-specified image features.

CV techniques may be used in various applications besides image retrieval, such as facial recognition, which is to identify or verify a person from a digital image or a video. An important CV technique is embedding learning. Informative pairs of instances, in the same class or different classes, are typically used to train an embedding learning model, so that it can learn an embedding space where instances from the same class are encouraged to be closer than those from different classes.

Mining informative instances are critical for embedding learning. However, conventional techniques often are being constrained by a limited number of informative instances or pairs of instances. A technical solution is needed to explore advanced techniques to increase the number of informative instances or pairs of instances. In this way, more accurate or efficient CV techniques may be developed to improve the performance of various CV applications.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

In general, aspects of this disclosure include a technical solution for embedding learning. To do that, the disclosed system is to use a cross-batch memory (XBM) technique that memorizes the embeddings in the present and past iterations. Accordingly, the XBM technique enables more informative instances or their pairing information, including hard negative pairs across multiple mini-batches, to be collected for embedding learning in various CV applications. The disclosed technologies can be integrated into many pair-based deep metric learning (DML) systems, and improve their performance by a large margin. Further, The disclosed technologies also significantly improve memory efficiency for such DML systems.

In various aspects, systems, methods, and computer-readable storage devices are provided to improve a computing system's ability for embedding learning and corresponding CV applications in general. Specifically, one aspect of the technologies described herein is to improve a computing system's performance for content-based image retrieval (CBIR) applications, including product recognition, face recognition, etc. Another aspect of the technologies described herein is to improve the memory efficiency of such CV systems.

### BRIEF DESCRIPTION OF THE DRAWINGS

The technologies described herein are illustrated by way of example and not limited in the accompanying figures in which like reference numerals indicate similar elements and in which:

FIG. 1 is a block diagram of an exemplary learning system, in accordance with at least one aspect of the technologies described herein;

FIG. 2 is a schematic representation illustrating exemplary learning process, in accordance with at least one aspect of the technologies described herein;

FIG. 3 are plots illustrating some results of an experiment with an exemplary system, in accordance with at least one aspect of the technologies described herein;

FIG. 4 are plots illustrating other results of an experiment with an exemplary system, in accordance with at least one aspect of the technologies described herein;

FIG. 5 is a flow diagram illustrating an exemplary process of embedding learning, in accordance with at least one aspect of the technologies described herein;

FIG. 6 is a flow diagram illustrating an exemplary process of operating a cross-batch memory, in accordance with at least one aspect of the technologies described herein; and

FIG. 7 is a block diagram of an exemplary computing environment suitable for use in implementing various aspects of the technologies described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the term “based on” generally denotes that the succedent condition is used in performing the precedent action.

A high-level understanding of image similarities is a key CV problem. To measure the similarity between images, images are typically embedded in a feature vector space, in which the distance between two embeddings represents their relative similarity or dissimilarity. Such vector space representations are used in CV applications such as image retrieval, classification, or visualizations.

Deep metric learning (DML) aims to learn an embedding space where instances from the same class are encouraged to be closer than those from different classes. As a fundamental problem in computer vision, DML has been applied to various tasks, including advanced image retrieval, face recognition, zero-shot learning, visual tracking, person identification, etc.

Some DML approaches, such as contrastive loss, triplet loss, lifted-structure loss, n-pairs loss, multi-similarity (MS) loss, etc., are pair-based, whose objectives can be defined in terms of pair-wise similarities within a mini-batch. Moreover, most existing pair-based DML methods can be unified as weighting schemes under a general pair weighting (GPW) framework. Informative pairs include both negative pairs and positive pairs. The performance of pair-based methods heavily relies on their capability of mining informative negative pairs. To collect sufficient informative negative pairs from each mini-batch, conventional efforts have been devoted to improving the sampling scheme, which can be categorized into two main directions: (1) sampling informative mini-batches based on global data distribution; and (2) weighting informative pairs within each individual mini-batch.

Pair-based DML methods may be optimized by computing the pair-wise similarities between instances in the embedding space. Contrastive loss is one of the classic pair-based DML methods, which learns a discriminative metric via Siamese networks. Contrastive loss encourages the deep features of positive pairs to get closer to each other and those of negative pairs to be farther than a fixed threshold. Differently, triplet loss requires the similarity of a positive pair to be higher than that of a negative pair (with the same anchor) by a given margin.

Inspired by contrastive loss and triplet loss, several pair-based DML models have been developed to weight all pairs in a mini-batch, such as up-weighting informative pairs (e.g. N-pair loss, MS loss) through a log-exp formulation, or sampling negative pairs uniformly regarding pair-wise distance. Other DML methods have also been developed to optimize the embedding by comparing each sample with proxies, such as proxy NCA, NormSoftmax, and SoftTriple.

Most deep models are trained with stochastic gradient descent (SGD) wherein only a mini-batch of samples is accessible at each iteration. However, the size of a mini-batch can be relatively small compared to the whole dataset, especially for the modern large dataset in modern CV applications. Moreover, a large fraction of the pairs is not very informative as the model learns to embed the trivial pairs correctly. In summary, the lack of hard negative pairs seriously impedes the performance of the conventional pair-based DML techniques, even when some approaches have been developed to increase the potential information contained in a mini-batch, such as building a class-level hierarchical tree, updating class-level signatures to select hard negative instances, or obtaining samples from an individual cluster.

Mining informative instances, especially hard negative pairs, are of central importance to the DML system. However, the hard-mining ability of existing DML methods is intrinsically limited by conventional mini-batch training in which only a mini-batch of instances is accessible at each iteration. No matter how sophisticated the sampling scheme is, the hard mining ability of a DML system is essentially limited by the size of mini-batch, which determines the number of possible training pairs.

Conventional methods try to boost the performance of pair-based DML methods by enlarging the mini-batch size. Theoretically, the mini-batch size may be enlarged to cover the whole dataset. By way of example, a naive system can collect informative pairs by computing the features of instances in the whole dataset before each training iteration, and then search hard negative pairs from the whole dataset. However, such naive solutions would be extremely time-consuming, especially for a large-scale dataset.

Further, enlarging mini-batch is not a technically effective answer to solve the hard mining problem at least due to two drawbacks: (1) the mini-batch size is generally limited by the GPU memory and computational cost; and (2) a large mini-batch often requires cross-device synchronization, which is a challenging engineering task.

To improve the conventional systems, including breaking the limit of mining informative instances and their pair information (e.g., hard negatives) within a single mini-batch, a technical solution is disclosed herein for embedding learning augmented with cross-batch memory (XBM), which will be further discussed in connection with various figures.

Traditionally, the embeddings of an instance in the past iterations are deemed as unusable for the present iteration due to feature drifting. The disclosed technologies herein are partially based on an interesting discovery, “slow drift,” that the embedding of an instance drifts at a relatively slow rate (i.e., becomes relatively stable) after some iterations. It suggests that the deep features of a mini-batch computed at past iterations can be approximated to those extracted in the present iteration. Accordingly, an XBM module is disclosed herein to record and update the deep features of recent mini-batches, and to mine informative instances across mini-batches in a novel way. The XBM module is to dynamically update the embeddings of instances of recent mini-batches, which enables a DML system to collect sufficient hard negative pairs across multiple mini-batches, or even from the whole dataset. Resultantly, this XBM-based cross-batch mining technology provides additional hard negative pairs based at least in part by directly connecting each anchor in the current mini-batch with embeddings from previous mini-batches.

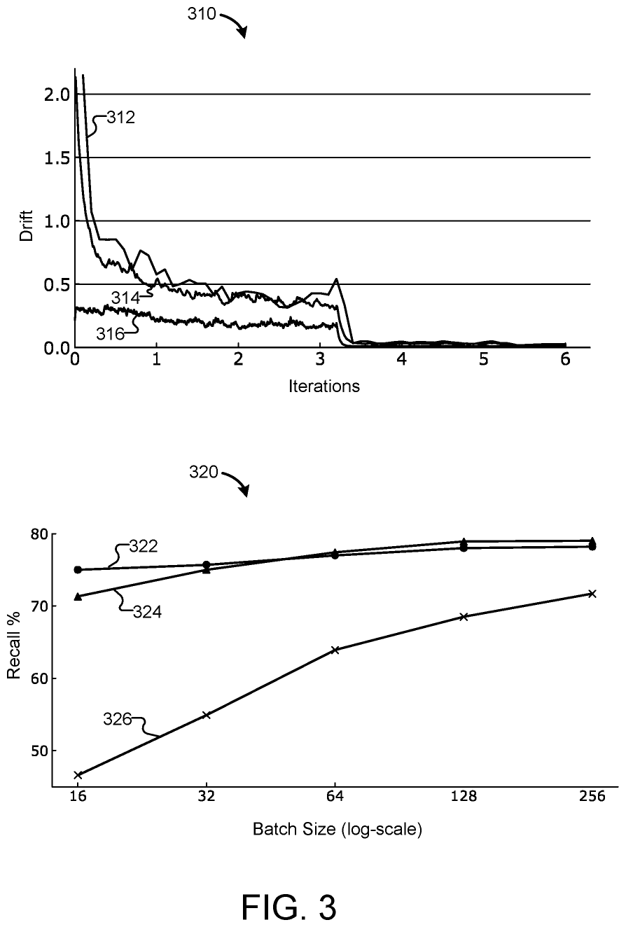

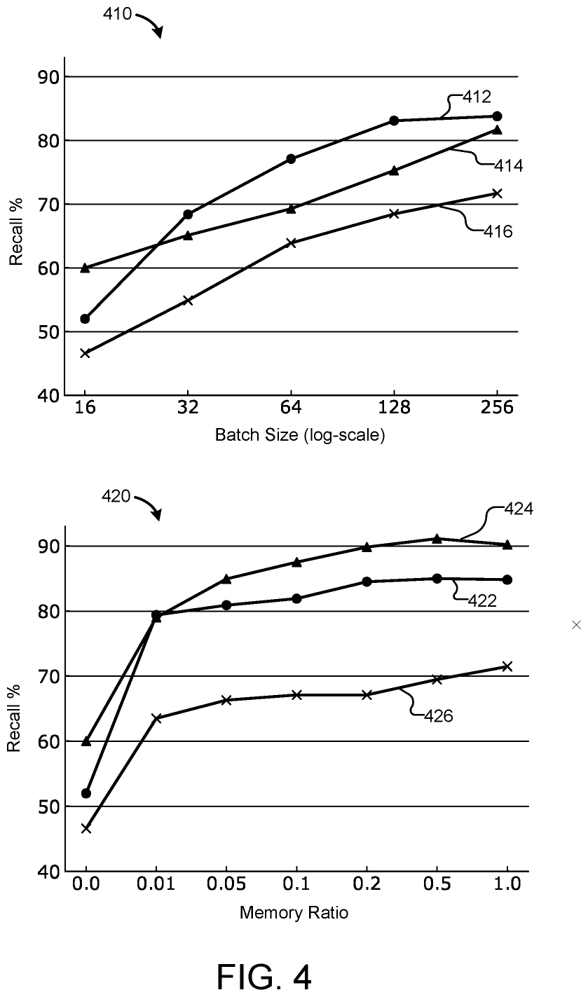

Further, the disclosed cross-batch mining technology may be integrated into many pair-based DML systems to boost their performances considerably. For example, the XBM module can improve the performance of many pair-based methods significantly on various CV tasks, e.g., image retrieval. In some experiments, with the disclosed cross-batch mining technology, a DML system with a basic contrastive loss has surpassed many state-of-the-art methods by a large margin on three large-scale datasets that are being tested, which will be further discussed in connection with FIGS. 3-4.

Unlike some conventional approaches, which aim to enrich individual mini-batch, the disclosed technologies are designed to directly mine hard negative examples across multiple mini-batches. Advantageously, the disclosed technologies can provide a rich set of negative examples for pair-based DML methods, which is more generalized and can make full use of past embeddings. Regarding known feature memory modules, e.g., the non-parametric memory module of embeddings, such as using external memory to address the unaffordable computational demand of conventional NCA in large-scale recognition or to encourage instance-invariance in domain adaptation, those feature memory modules generally optimize positive pairs only. In contrast, the disclosed technologies excel in finding hard negative pairs. Further, the known feature memory modules either only store the embeddings of current mini-batch or maintain the whole dataset with moving average update. However, the XBM is maintained as a dynamic queue of mini-batches, which is more flexible and applicable in large-scale datasets.

Compared to conventional proxy-based methods, proxies are often optimized along with the model weights, while the embeddings of the disclosed technologies are directly taken from past mini-batches. Further, proxies are used to represent the class-level information, whereas the embeddings of XBM are evaluated at instance-level while capturing the global information (e.g., via XBM augmented cross-batch pairs) of the whole dataset during training.

Further, some known approaches tried to provide more negative samples for unsupervised learning using specific encoding networks to compute additional features of the current mini-batch. However, in the XBM-based approach, the features are computed more efficiently by taking them directly from the forward of the current model with no additional computational cost. For example, the XBM module can be updated using an enqueue and dequeue mechanism by leveraging the computation-free features computed at the past iterations, which only takes negligible extra GPU memory in some embodiments.

More importantly, some known approaches designed a momentum update that slowly progressed the key encoder to ensure consistency between different iterations. In contrast, the XBM-based approach does not need to require any complicated encoders or momentum updates; instead, the XBM-based approach simply actives the XBM only after the early phase of training, e.g., after a selected point of time when the features become stable, a.k.a., entering the “slow drift” phase, such that features of embeddings in different iterations remain relatively consistent.

Advantageously, the disclosed technologies have a superior hard mining ability, including providing robust negative examples for many pair-based DML methods. To investigate the hard mining ability of the XBM technique, in one experiment, the amount of valid negative pairs produced via the XMB at each iteration is studied, in which a negative pair with non-zero gradient is considered as valid. The statistical result demonstrates that, throughout the training procedure, the XMB module steadily contributes about 1,000 hard negative pairs per iteration, whereas less than 10 valid pairs are generated by the conventional method.

Qualitative hard mining results also demonstrate the superior hard mining ability of the disclosed technologies. The conventional mini-batch mechanism can only bring a few valid negatives with less information, while the XBM technique can provide a wide variety of informative negative examples. In one experiment, given a bicycle image as an anchor, the conventional mini-batch mechanism provides limited and different images, e.g. roof and sofa, as negatives. In stark contrast, the XBM technique offers both semantically bicycle-related images and other samples, e.g. wheel and clothes. These results demonstrate that the XBM technique can provide diverse, related, and even fine-grained samples to construct negative pairs.

The experimental results confirm that (1) existing pair-based approaches suffer from the problem of lacking informative negative pairs to learn a discriminative model, and (2) the XBM module can significantly strengthen the hard mining ability to exist pair-based DML techniques effectively and efficiently.

The disclosed technologies can be applied in various CV tasks, such as CBIR, face recognition, or ProductAI® by Malong Technologies, which provides state-of-the-art application programming interfaces (APIs) and embedded systems for visual product recognition. ProductAI® enables a machine to “see” products like a person, and recognize them holistically, with or without the need for barcodes or other machine-readable labels (MRLs). The disclosed technologies further boost the utility and effectiveness of ProductAI® for high-performance image retrieval and auto-tagging for products, such as fashion, furniture, textiles, wine, food, and other retail products.

In summary, the disclosed technologies created a new path for hard negative mining which can fundamentally enhance various computer vision tasks. Furthermore, the disclosed dynamic memory mechanism via XBM may be extended to improve a wide variety of machine learning tasks other than DML, as “slow drift” is likely a general phenomenon that does not just exist in DML.

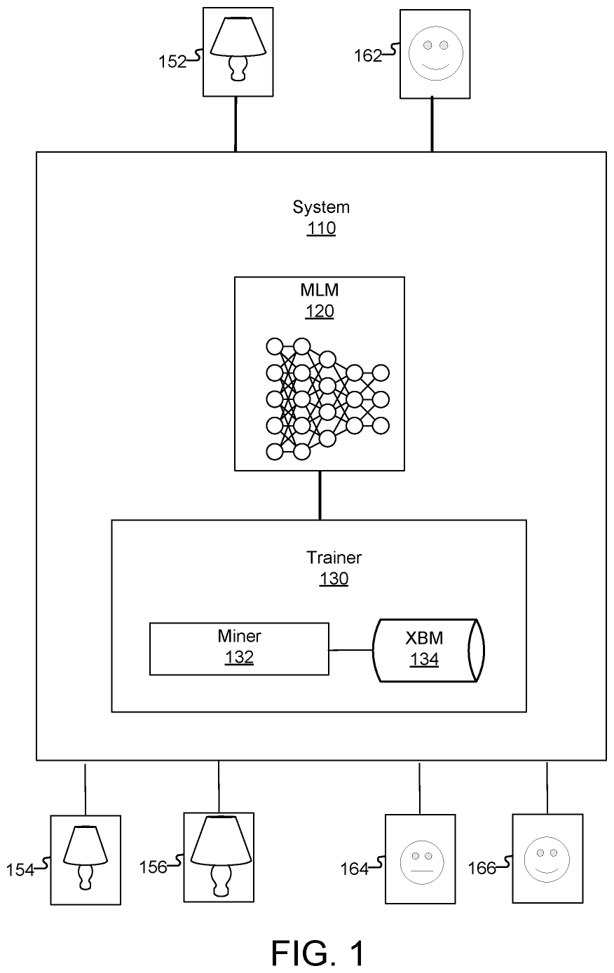

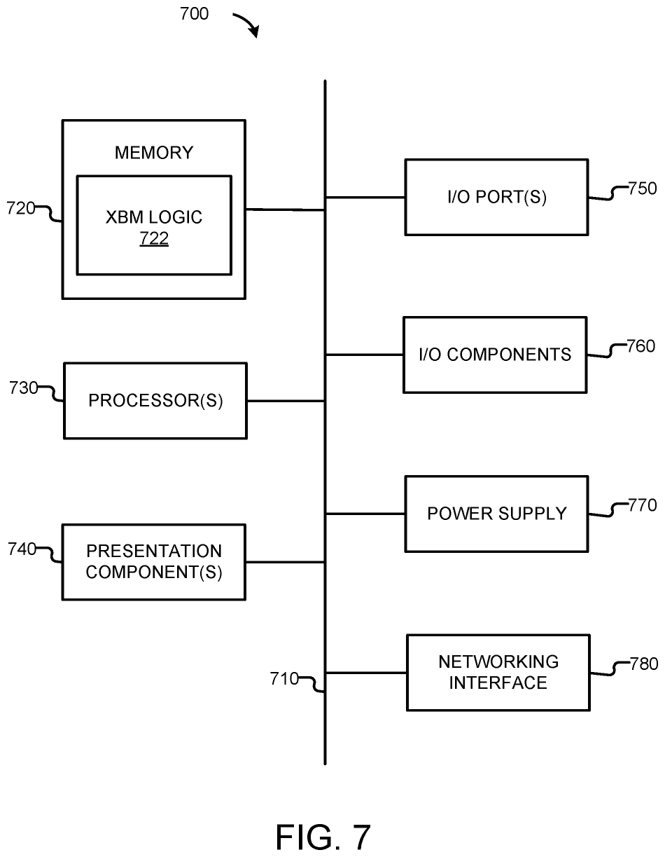

Having briefly described an overview of aspects of the technologies described herein, referring now to FIG. 1, an exemplary learning system (system 110) is described below for implementing at least one aspect of the disclosed technologies. In addition to other components not shown here, system 110 includes machine learning module (MLM) 120 and trainer 130 operatively coupled with each other. Further, trainer 130 includes miner 132 and XBM 134 operatively coupled with each other. It should be understood that each of the components shown in system 110 may be implemented on any type of computing devices, such as computing device 700 described in FIG. 7. Further, each of the components may communicate with various external devices via a network, which may include, without limitation, a local area network (LAN) or a wide area network (WAN).

In some embodiments, system 110 is configured to enable machines empowered by ProductAI® to recognize products without the need for scanning barcodes. In one embodiment, system 110 may receive a product image, for example, image 152. Thereafter system 110 will classify the product in image 152 and generate a corresponding label for the product. In one embodiment, system 110 may receive multiple product images, for example, image 154 and image 156. Thereafter system 110 will recognize the product in the multiple images and output a representative image of the product, such as image 152, as a visual confirmation of such product recognition.

In some embodiments, system 110 is configured as a CBIR system. In one embodiment, system 110 may embed an input image, such as image 152, into a high dimensional vector space. Subsequently, this embedding may be compared with other embeddings in the same vector space for measuring their similarities. The output from system 110 may include a list of images, ranked based on their respective similarity measures with the input image.

In some embodiments, system 110 is configured for face recognition. In one embodiment, system 110 may receive a face image, for example, image 162. System 110 is to determine a similarity measure between features of the face image with features of a labeled face image, such as image 164 or image 166, and further to determine whether the input face image matches the labeled face image based on such similarity measure.

In other embodiments, system 110 may be configured for other computer vision tasks, such as quality control, e.g., in manufacturing applications; process control, e.g., with an industrial robot; event detection or object detection, e.g., for surveillance; object modeling, e.g., medical image analysis or topographical modeling; navigation, e.g., by an autonomous vehicle or mobile robot; etc.

For performing a CV task, system 110 may use a machine learning model implemented via, e.g., MLM 120, which may include one or more neural networks in various embodiments. As used herein, a neural network comprises at least three operational layers, such as an input layer, a hidden layer, and an output layer. Each layer comprises neurons. The input layer neurons pass data to neurons in the hidden layer. Neurons in the hidden layer pass data to neurons in the output layer. The output layer then produces a classification. Different types of layers and networks connect neurons in different ways.

Every neuron has weights, an output, and an activation function that defines the output of the neuron based on an input and the weights. The weights are the adjustable parameters that cause a network to produce the correct output. The weights are adjusted during training. Once trained, the weight associated with a given neuron can remain fixed. The other data passing between neurons can change in response to a given input (e.g., image).

The neural network may include more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM) (which is a type of recursive neural network). Some embodiments described herein use a convolutional neural network, but aspects of the technology are applicable to other types of multi-layer machine classification technology.

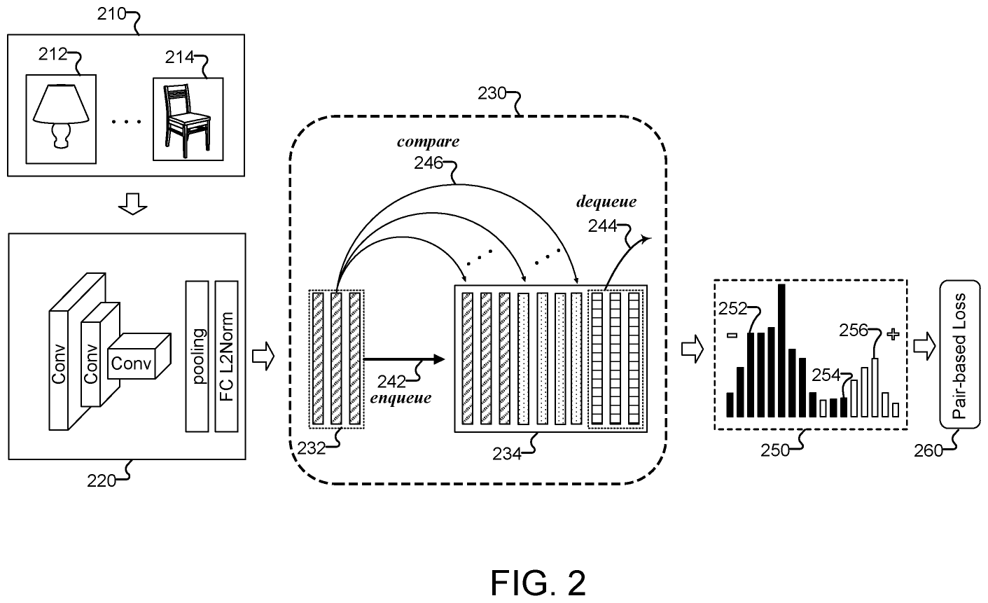

Trainer 130 may use training data (e.g., labeled or unlabeled training images) to train MLM 120 during the training phase, so that MLM 120 may classify or recognize an input (e.g., an input image) during the inference phase, as described herein in various CV applications. Although examples are described herein with respect to using neural networks, and specifically convolutional neural networks in network 220 in FIG. 2, this is not intended to be limiting. For example, and without limitation, MLM 120 may include any type of machine learning model, such as a machine learning model(s) using linear regression, logistic regression, decision trees, support vector machines (SVM), Naive Bayes, k-nearest neighbor (KNN), K means clustering, random forest, dimensionality reduction algorithms, gradient boosting algorithms, neural networks (e.g., auto-encoders, convolutional, recurrent, perceptrons, long/short term memory/LSTM, Hopfield, Boltzmann, deep belief, deconvolutional, generative adversarial, liquid state machine, etc.), and/or other types of machine learning models.

Within trainer 130, miner 132 is configured to mine informative instances or samples from the training dataset to train MLM 120. Specifically, in some embodiments, miner 132 is to mine intra-batch (in the same mini-batch) and inter-batch (across different mini-batches) informative instances, particularly negative pairs for pair-based DML methods, which may use contrastive loss, triplet loss, lifted-structure loss, n-pairs loss, multi-similarity (MS) loss, etc.

The mining function of miner 132 is augmented by XBM 134, which is a cross-batch memory module. XBM 134 is configured to memorize the embeddings of the present and past iterations, such that more informative instances or their pairing information, including hard negative pairs across multiple mini-batches may be collected from the mini-batches in a particular iteration.

System 110 is merely one example of a suitable computing environment and is not intended to suggest any limitation as to the scope of use or functionality of aspects of the technologies described herein. Neither should this system be interpreted as having any dependency or requirement relating to any one component nor any combination of components illustrated.

It should be understood that this arrangement in system 110 is set forth only as an example. Other arrangements and elements (e.g., machines, networks, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Further, various functions described herein as being performed by an entity may be carried out by hardware, firmware, and/or software. For instance, some functions may be carried out by a processor executing instructions stored in memory.

Referring to FIG. 2, an exemplary learning process is shown for implementing at least one aspect of the disclosed technologies. Network 220 includes a CNN, which is configured to receive mini-batch 210 and generate neural features for each image in mini-batch 210, such that each instance (e.g., image 212 or image 214) is embedded into the feature space based on its neural features. Embeddings 232 includes neural features for each image in mini-batch 210.

Network 220 may include any number of layers, such as the layers illustrated in FIG. 2. The objective of one type of layers (e.g., Convolutional, Relu, and Pool) may be configured to extract features of the input volume, while the objective of another type of layers (e.g., FC and Softmax) may be configured to classify an input based on the extracted features.

An input layer of network 220 may hold values associated with an instance in mini-batch 210. For example, when the instance is an image(s), the input layer may hold values representative of the raw pixel values of the image(s) as a volume, such as W×H×C (a width, W; a height, H; and color channels, C (e.g., RGB)), or a batch size, B.

One or more layers in network 220 may include convolutional layers. The convolutional layers may compute the output of neurons that are connected to local regions in an input layer (e.g., the input layer), each neuron computing a dot product between their weights and a small region they are connected to in the input volume. In a convolutional process, a filter, a kernel, or a feature detector includes a small matrix used for feature detection. Convolved features, activation maps, or feature maps are the output volume formed by sliding the filter over the image and computing the dot product. An exemplary result of a convolutional layer can be another volume, with one of the dimensions based on the number of filters applied (e.g., the width, the height, and the number of filters, F, such as W×H×F, if F were the number of filters).

One or more of the layers may include a rectified linear unit (ReLU) layer. The ReLU layer(s) may apply an elementwise activation function, such as the max (0, x), thresholding at zero, for example, which turns negative values to zeros (thresholding at zero). The resulting volume of a ReLU layer may be the same as the volume of the input of the ReLU layer. In some embodiments, this layer does not change the size of the volume, and there are no hyperparameters.

One or more of the layers may include a pool or pooling layer. A pooling layer performs a function to reduce the spatial dimensions of the input and control overfitting. There are different functions such as Max pooling, average pooling, or L2-norm pooling. In some embodiments, max pooling is used, which only takes the most important part (e.g., the value of the brightest pixel) of the input volume. By way of example, a pooling layer may perform a down-sampling operation along the spatial dimensions (e.g., the height and the width), which may result in a smaller volume than the input of the pooling layer (e.g., 16×16×12 from the 32×32×12 input volume). In some embodiments, the convolutional network may not include any pooling layers. Instead, strided convolution layers may be used in place of pooling layers.

One or more of the layers may include a fully connected (FC) layer. A FC layer connects every neuron in one layer to every neuron in another layer. The last FC layer normally uses an activation function (e.g., Softmax) for classifying the generated features of the input volume into various classes based on the training dataset. The resulting volume can take the shape of “1×1×number of classes.”

Further, calculating the length or magnitude of vectors is often required either directly as a regularization method in machine learning, or as part of broader vector or matrix operations. The length of the vector is referred to as the vector norm or the vector's magnitude. The L1 norm is calculated as the sum of the absolute values of the vector. The L2 norm is calculated as the square root of the sum of the squared vector values. The max norm is calculated as the maximum vector values.

As discussed previously, some of the layers may include parameters (e.g., weights and/or biases), such as a convolutional layer, while others may not, such as the ReLU layers and pooling layers, for example. In various embodiments, the parameters may be learned or updated during training. Further, some of the layers may include additional hyper-parameters (e.g., learning rate, stride, epochs, kernel size, number of filters, type of pooling for pooling layers, etc.), such as a convolutional layer or a pooling layer, while other layers may not, such as a ReLU layer. Various activation functions may be used, including but not limited to, ReLU, leaky ReLU, sigmoid, hyperbolic tangent (tanh), exponential linear unit (ELU), etc. The parameters, hyper-parameters, and/or activation functions are not to be limited and may differ depending on the embodiment.

Although input layers, convolutional layers, pooling layers, ReLU layers, and FC layers are discussed herein, this is not intended to be limiting. For example, additional or alternative layers, such as normalization layers, softmax layers, and/or other layer types, may be used in network 220.

Different orders and numbers of the layers of network 220 may be used depending on the embodiment. For example, a particular number of layers arranged in a particular order may be configured for one type of CV application (e.g., ProductAI®), whereas a different number of layers in a different order may be configured for another type of CV application (e.g., face recognition). In other words, the order and number of layers of the convolutional network are not limited to any one architecture.

In various embodiments, network 220 may be trained with labeled images using multiple iterations until the value of a loss function(s) of the machine learning model is below a threshold loss value. One or more loss functions may be used to measure errors in the predictions of the machine learning model using ground truth values.

The number of epochs is a hyperparameter that defines the number iterations that the learning algorithm will work through the entire training dataset. One epoch means that each sample in the training dataset has had an opportunity to update the internal model parameters. The number of epochs is traditionally large, often hundreds or thousands, allowing the learning algorithm to run until the error from the model has been sufficiently minimized.

A training dataset typically comprises many samples. A sample may also be called an instance, an observation, an input vector, or a feature vector. In various embodiments, an epoch is comprised of one or more batches. When all training samples are used to create one batch, the learning algorithm is called batch gradient descent. When the batch is the size of one sample, the learning algorithm is called stochastic gradient descent. When the batch size is more than one sample and less than the size of the training dataset, the learning algorithm is called mini-batch gradient descent.

Mini-batch gradient descent is a variation of the gradient descent algorithm that splits the training dataset into small batches that are used to calculate model error and update the learning model coefficients. Mini-batch gradient descent seeks to find a balance between the robustness of stochastic gradient descent and the efficiency of batch gradient descent.

The mini-batch size, or the batch size for brevity, is a hyperparameter that defines the number of samples to work through before updating the internal model parameters, which is often chosen as a power of two that fits the memory requirements of the GPU or CPU hardware like 32, 64, 128, 256, and so on. Small values for the batch size are believed to enable the learning process to converge quickly at the cost of noise in the training process, while large values may offer more accurate estimates of the error gradient. In various embodiments, a default batch size of 32, 64, or 128 is used.

In summary, the batch size and number of epochs for a learning algorithm are both hyperparameters for the learning algorithm, e.g. parameters for the learning process, not internal model parameters found by the learning process. Batch size is a number of samples processed before the model is updated. The number of epochs is the number of complete passes or iterations through the training dataset. In various embodiments, the batch size and number of epochs are preset for the learning model. The size of a batch must be more than or equal to one and less than or equal to the number of samples in the training dataset. The number of epochs can be set to an integer value between one and infinity.

FIG. 2 illustrates an exemplary process for the disclosed system to process one mini-batch in one epoch with XBM 230. A cross-batch memory module (e.g., XBM 230) may be integrated into an existing pair-based DML framework as a plug-and-play module, e.g., by following the Pseudocode of XBM as listed below. The activation, initialization, updating, and other operations related to a cross-batch memory module will be further discussed in connection with the remaining figures.

Pseudocode of XBM

```
train network f conventionally with K epochs
initialize XBM as queue M
for x, y in loader: # x: data, y: labels
anchors = f.forward(x)
  # memory update
  enqueue(M, (anchors.detach( ), y))
  dequeue(M)
  # compare anchors with M
  sim = torch.matmul(anchors.transpose( ), M.feats)
  loss = pair_based_loss(sim, y, M.labels)
  loss.backward( )
  optimizer.step( )
```

In some embodiments, XBM 230 is maintained and updated as a queue. An embedding in embeddings 232 includes the features of an instance of the current mini-batch in the feature space (thus called “embedding” for brevity), which are determined by network 220. The operations associated with XBM 230 includes operation 242 of enqueuing the embeddings and labels of the current mini-batch in embeddings 232, and operation 244 of dequeuing the embeddings of an earlier mini-batch. Thus, XBM 230 may be updated with embeddings of the current mini-batch directly without any additional computation. In some embodiments, the whole training set can be cached in the memory module because XBM 230 only requires very limited memory for storing the embedding features, which may be represented via 512-d float vectors in some embodiments. In such embodiments, the dequeuing operation may not be performed.

Further, an embedding of the current mini-batch in embeddings 232 is selected as the anchor. The anchor is compared, via operation 246, to each of the embeddings in XBM 230 to compute their respective similarity measures and losses. Further, backpropagation is applied to minimize the error. The current error is typically propagated backward to a previous layer, where it is used to modify the weights and bias in such a way to minimize the error. The weights may be modified using an optimization function.

Based on the previous operations associated with XBM 230, informative pairs of instances may be identified in operation 250. By way of example, after operation 246, embedding pairs may be ranked based on their similarity measures (e.g., based on a Sim( ) function) and labels (e.g., negative for being in different classes, or positive for being in the same class). In this example, bar 252 represents negative embedding pairs with relatively low similarity scores; bar 254 represents hard negative embedding pairs with relatively high similarity scores, and bar 256 represents positive embedding pairs with relatively high similarity scores. In some embodiments, hard negative embedding pairs are selected for training network 220 due to their high discrimination power, e.g., via pair-based losses computed at operation 260.

In summary, in various embodiments, XBM 230 augments the learning model to train an embedding network (e.g., network 220) by comparing each anchor with each embedding in the cross-batch memory using a pair-based loss. The cross-batch memory may be maintained as a queue with the current mini-batch enqueued and optionally some embeddings from an earlier mini-batch been dequeued. Advantageously, this XBM-augmented DML enables a large number of valid negatives for each anchor to benefit the model training for many pair-based methods, and overcoming the lack of informative instance issues plagued conventional DML models. Based on the “slow drift” phenomenon, XBM may be integrated into many existing DML models, and XBM-augmented DML models can achieve significant technical improvements.

Specifically, let [symbol] ={x₁, x₂, . . . , x_{N}} denotes the training instances, and [symbol] ᵢ is the corresponding label of x₁. The embedding function, ƒ(⋅; θ), projects a data point x₁ onto a D-dimensional unit hyper-sphere, vᵢ=ƒ(xᵢ; θ). In some embodiments, the similarity of a pair of instances (i.e., the Sim( ) function) may be measured through the cosine similarity of their embeddings. During training, the affinity matrix of all pairs within current mini-batch is denoted as S, whose (i, j) element is the cosine similarity between the embeddings of the i-th sample and the j-th sample: vᵢ^{T}vⱼ.

With the GPW framework, a pair-based function can be cast to a unified pair-weighting form via Eq. 1, where m is the mini-batch size and ωᵢⱼ is the weight assigned to Sᵢⱼ. Here, any pair-based methods may be treated as a weighting scheme focusing on informative pairs. Several weighting schemes, including contrastive loss, triplet loss, and MS loss, are discussed below.

$$ℒ = \frac{1}{m} {\sum }_{i = 1}^{m} [ {\sum }_{{y}_{j} \neq {y}_{i}}^{m} {ω}_{ij} {S}_{ij} - {\sum }_{{y}_{j} = {y}_{i}}^{m} {ω}_{ij} {S}_{ij} ] , \qquad ( Eq . 1 )$$

Regarding contrastive loss, for each negative pair, ωᵢⱼ=1 if Sᵢⱼ>λ, otherwise ωᵢⱼ=0. The weights of all positive pairs are 1.

Regarding triplet loss, for each negative pair, ωᵢⱼ=| [symbol] ᵢⱼ|, wherein [symbol] ᵢⱼ is the valid positive set sharing the anchor. Formally, and {x_{i,k}|yₖ=yᵢ, and Sᵢₖ<Sᵢⱼ+η} and η is the predefined margin in triplet loss. Similarly, the triplet weight for a positive pair may be obtained.

Regarding MS loss, unlike contrastive loss and triplet loss that only assign an integer weight value, MS loss can weigh the pairs more properly by jointly considering multiple similarities. The MS weight for a negative pair may be computed via Eq. 2, where β and λ, are hyper-parameters, and Nᵢ is the valid negative set of the anchor xᵢ. the MS weights of the positive pairs are similar.

$${ω}_{ij} = \frac{{e}^{β} ( {S}_{ij} - λ )}{1 + {\sum }_{κ ∈ {N}_{i}} {e}^{β ( {S}_{ik} - λ )}} \qquad ( Eq . 2 )$$

An objective for developing pair-based DML is to design a better weighting mechanism for pairs within a mini-batch. Under a small mini-batch (e.g. 16 or 32), the sophisticated weighting schemes can perform much better. However, beyond the weighting scheme, the mini-batch size is also of great importance to DML. Conventional wisdom is to develop sophisticated but highly complicated methods to weight the informative pairs.

In contrast, the XBM approach is to simply collect sufficient informative negative pairs, where a simple weighting scheme based on the contrastive loss can be used to outperform many stage-of-the-art weighting approaches. This provides a new path that is straightforward yet more efficient to solve the hard mining problem in DML.

The XBM approach can perform hard negative mining with the XBM on the pair-based DML. For a pair-based loss, based on the GPW, it can be cast into a unified weighting formulation of pair-wise similarities within a mini-batch in Eq. 1, where a similarity matrix is computed within a mini-batch, S. To perform the XBM technique, one can compute a cross-batch similarity matrix \tilde{S} between the instances of current mini-batch and the memory bank.

Formally, the memory augmented pair-based DML can be formulated via Eq. 4, where \tilde{S}ᵢⱼ=vᵢ^{T}\tilde{v}ⱼ.

$$ℒ = \frac{1}{m} {\sum }_{i = 1}^{m} {ℒ}_{i} = {\sum }_{i = 1}^{m} [ {\sum }_{{\tilde{y}}_{j} \neq {\tilde{y}}_{i}}^{M} {w}_{ij} {\tilde{S}}_{ij} - {\sum }_{{\tilde{y}}_{j} = {\tilde{y}}_{i}}^{M} {w}_{ij} {\tilde{S}}_{ij} ] \qquad Eq . ( 4 )$$

The memory augmented pair-based loss in Eq. 4 is similar to the normal pair-based loss in Eq. 1, with a new similarity matrix \tilde{S}. Each instance in the current mini-batch is compared with all the instances stored in the memory, enabling the XMB approach to collect sufficient informative pairs for training. The gradient of the loss [symbol] regarding vᵢ is presented in Eq. 5, and the gradients regarding vᵢ model parameters θ can be computed through a chain rule via Eq. 6.

$$\begin{matrix}\frac{\partial {i}_{}}{\partial θ} = {\sum }_{{\tilde{y}}_{j} \neq {\tilde{y}}_{i}}^{M} {w}_{ij} {\tilde{v}}_{j} - {\sum }_{{\tilde{y}}_{j} = {\tilde{y}}_{i}}^{M} {w}_{ij} {\tilde{v}}_{j} & ( Eq . 5 ) \\ \frac{\partial {ℒ}_{i}}{\partial θ} = \frac{\partial {ℒ}_{i}}{\partial {v}_{i}} \frac{\partial {v}_{i}}{\partial θ} & ( Eq . 6 )\end{matrix}$$

Finally, the model parameters θ are optimized through stochastic gradient descent. Lemma 1 below ensures that the gradient error raised by embedding drift can be strictly constrained with a bound, which minimizes the side effect to the model training.

Now referring to FIG. 3, selected plots illustrate the results of an experiment with an exemplary system implementing at least one aspect of the disclosed technologies. Specifically, plot 310 illustrates the “slow drift” phenomena, while plot 320 illustrates the significant improvements made by the XBM-based approaches. Specifically, based on the “slow drift” phenomena as described below and illustrated in plot 310, the XBM-related technologies allow the integrated DML model to collect more informative pairs over multiple mini-batches, in turn, significantly improve the recall as illustrated in plot 320.

A straightforward solution to collect more informative negative pairs is to increase the mini-batch size. However, training deep networks with a large mini-batch is often limited by memory (e.g., GPU memory). GPUs can process neural network workloads orders of magnitude faster than general-purpose CPUs can, but each GPU usually has a relatively small amount of RAM. Training with oversized mini-batches is often prohibitive due to massive inter-CPU or inter-GPU communication because such training requires massive data flow communication between multiple CPUs or GPUs. To this end, the XBM-based solution introduces an improved approach with very low GPU memory consumption and minimum extra computation burden. Resultantly, the XBM-based training is much faster than conventional large-scale deep learning techniques with only marginally increased memory footprints.

When evaluating the disclosed technologies with various conventional pair-based DML techniques on three widely used large-scale image retrieval datasets: Stanford Online Products (SOP), Inshop Clothes Retrieval (In-shop), PKU VehicleID (VehicleID), the performance of both basic pair-based approaches (contrastive loss and MS loss) are improved strikingly when the mini-batch size grows larger on large-scale datasets, illustrated in FIGS. 3-4. This improvement is likely due to the number of negative pairs grows considerably with respect to the same mini-batch size after implementing the disclosed technologies.

Plot 310 shows epochs or iterations (using x1000 as the base) along the x-axis as time and the corresponding feature drift of measured instances on the y-axis. Line 312 is measured using 1000 iterations as the interval for measurement. Line 314 and line 316 are measured using 100 and 10 iterations as the interval respectively. The feature drift measures with different steps in plot 310 reveal that the embeddings of training instances drift within a relatively small distance even under a large interval, e.g. Δt=1000. Further, the embeddings become relatively stable after a limited number of iterations, e.g., 1000 iterations. Accordingly, 1000-3000 may be deemed as the sweet spot to warm up the model before activating the XBM in this case.

The “slow drift” phenomenon refers to the discovery that the embedding features drift exceptionally slow even as the model parameters are updating throughout the training process. It suggests that the features of instances computed at preceding iterations can considerably approximate to their features extracted at the current iteration. The XBM-based solution memorizes the embeddings of past iterations, allowing the model to collect sufficient hard negative pairs across multiple mini-batches or even over the whole dataset. When integrated into a general pair-based DML framework, without additional bells and whistles, XBM augmented DML can boost the performance considerably on image retrieval. By way of example, with XBM, a simple contrastive loss can have large R@1 improvements of 12%-22.5% on these three large-scale datasets, easily surpassing the most sophisticated state-of-the-art methods by a large margin. The XBM-based solution is conceptually superior, integrable with many DML systems, and memory efficient, e.g., consuming only negligible 0.2 GB extra GPU memory.

Traditionally, the embeddings of past mini-batches are usually considered as out-of-date since the model parameters are changing throughout the training process. Such out-of-date features are discarded previously, however, they can become an important yet computation-free resource after identifying the “slow drift” phenomena. The drifting speed of the embeddings may be measured by the difference of features for the same instance computed at different training iterations. Formally, the feature drift of an input x at t-th iteration with step Δt may be defined as Eq. 7.

D(x, t; Δt):=∥ƒ(x; θ^{t})−ƒ(x; θ^{t-Δt})μ2/2 Eq. 7

In one experiment, GoogleNet is trained from scratch with contrastive loss. The average feature drift for a set of randomly sampled instances is computed with different steps: {10, 100, 1000}, as shown in plot 310. The feature drift is consistently small within a small amount, e.g. 10 iterations. For the large steps, e.g. 100 and 1000, the features change drastically at the early phase but become relatively stable within about 3 K iterations. Furthermore, when the learning rate decreases, the drift gets extremely slow. This phenomena is denoted as “slow drift,” which suggests that after a certain number of training iterations, the embeddings of instances can drift very slowly, resulting in a marginal difference between the features computed at different training iterations.

Furthermore, such “slow drift” phenomena can provide a strict upper bound for the error of gradients of a pair-based loss, e.g., for simplicity, in view of the contrastive loss of one single negative pair

$$ℒ = υ \frac{T}{\dot{t}} {υ}_{j} ,$$

where υᵢ, υⱼ are the embeddings of the current model and \tilde{υ}ⱼ is an approximation of υⱼ.

Lemma 1. Assume

$$‖ {υ}_{j} - {\tilde{υ}}_{j} ‖ \frac{2}{2} < ϵ , \tilde{ℒ} = υ \frac{T}{\dot{t}} {\tilde{υ}}_{j}$$

and ƒ satisfies Lipschitz continuous condition, then the error of gradients related to υᵢ may be defined as Eq. 8, where C is the Lipschitz constant.

$$‖ \frac{\partial ℒ}{\partial θ} - \frac{\partial ℒ}{\partial θ} ‖ \frac{2}{2} < C ϵ , \qquad Eq . 8$$

Empirically, C is often less than 1 with the backbones used in the experiments. Lemma 1 suggests that the error of gradients is controlled by the error of embeddings under Lipschitz assumption. Thus, the “slow drift” phenomenon ensures that mining across mini-batches can provide negative pairs with valid information for pair-based methods.

Plot 320 illustrates the significant improvements made by the XBM approach. All lines are based on the performance of contrastive loss by training with different mini-batch sizes. As expected, the recall of these pair-based methods is increased considerably by using a larger mini-batch size on large-scale benchmarks, largely because the number of negative pairs increases quadratically when the mini-batch size grows, which naturally provides more informative pairs.

Line 326 is the baseline with contrastive loss. Line 322 illustrates the result after applying the XBM approach to the baseline, while line 324 uses the XBM approach and a random shuffle mini-batch sampler. The performance of the XBM augmented contrastive loss models significantly outperform the baseline model. Further, the XBM augmented contrastive loss model with the random shuffle mini-batch sampler appears to be equally effective.

[symbol]

Now referring to FIG. 4, selected plots illustrate the results of an experiment with an exemplary system implementing at least one aspect of the disclosed technologies. Plot 410 illustrates recall verses mini-batch size by varying datasets among SOP, In-shop, and VehicleID. Line 412 is associated with In-shop. Line 414 is associated with VehicleID. Line 416 is associated with SOP. Plot 420 illustrates recall verses memory ratio at mini-batch size 16 with contrastive loss. Line 422 is associated with In-shop. Line 424 is associated with VehicleID. Line 426 is associated with SOP.

In the experiment, the XBM approach exhibits excellent robustness and brings consistent performance improvements across all settings. Under the same configurations, the XBM approach obtains extraordinary recall improvements (e.g. over 20% for contrastive loss) on all three datasets compared with the corresponding conventional pair-based methods. Furthermore, with the XBM, a simple contrastive loss can easily outperform the state-of-the-art sophisticated methods by a large margin.

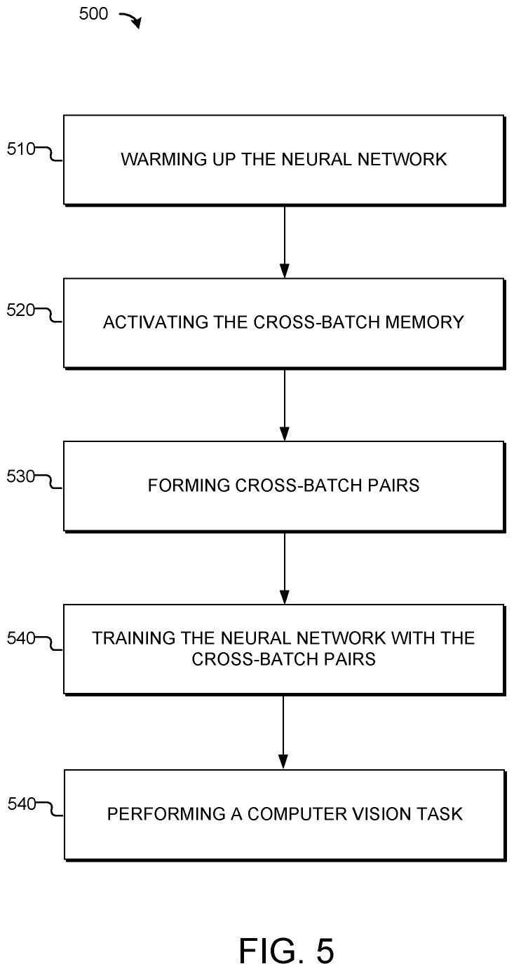

Referring now to FIG. 5, a flow diagram is provided that illustrates an exemplary process 500 of embedding learning, e.g., performed by system 110 of FIG. 1.

At block 510, the process is to warm up the neural network. In various embodiments, as the feature drift is relatively large at the early epochs, it is desirable to warm up the neural networks with some epochs (e.g., 1 k), allowing the model to reach a certain local optimal level where the embeddings become more stable. In various embodiments, the number of warming up epochs (e.g., the threshold) may be determined based on the underlying CV task. For example, one may select the threshold from the sweet spot observed from plot 310 in FIG. 3 for image retrieval applications. In one embodiment, the process is to measure a difference of embedding features for an instance at different epochs; and determine, based on the difference of the embedding features for the instance being less than a threshold, a number of epochs to warm up the neural network.

At block 520, the process is to activate the cross-batch memory. In some embodiments, the memory module may be activated by computing the features of a set of randomly sampled training images with the warm-up model. Formally, [symbol] ={(\tilde{v}₁), \tilde{y}₁), (\tilde{v}₂, \tilde{v}₂), . . . , \tilde{v}ₘ, \tilde{y}_{M})}, where \tilde{v}ᵢ is initialized as the embedding of the i-th sample xᵢ, and M is the memory size. A memory ratio may be defined as [symbol] :=M/N, the ratio of memory size to the training size N. Once the cross-batch memory is activated, embedding features of respective instances in different mini-batches may be stored in the cross-batch memory.

At block 530, the process is to form cross-batch pairs. In various embodiments, cross-batch pairs include both intra-batch and inter-batch pairs formed based on the XMB approach. In various embodiments, the process is to identify, based on the embedding features stored in the cross-batch memory, one or more negative pairs of instances in the different mini-batches.

At block 540, the process is to train the neural network with the cross-batch pairs. In some embodiments, the process is to update various weights and parameters of the neural network based on the one or more negative pairs of instances. This XMB-based training may be integrated with many pair-based DML models and CV applications. In some embodiments, the process includes computing a pair-based loss between an instance and each instance in the cross-batch memory to collect informative negative pairs for a pair-based model to train the neural network.

At block 550, the process is to perform a computer vision task, such as product recognition, face recognition, CBIR, etc.

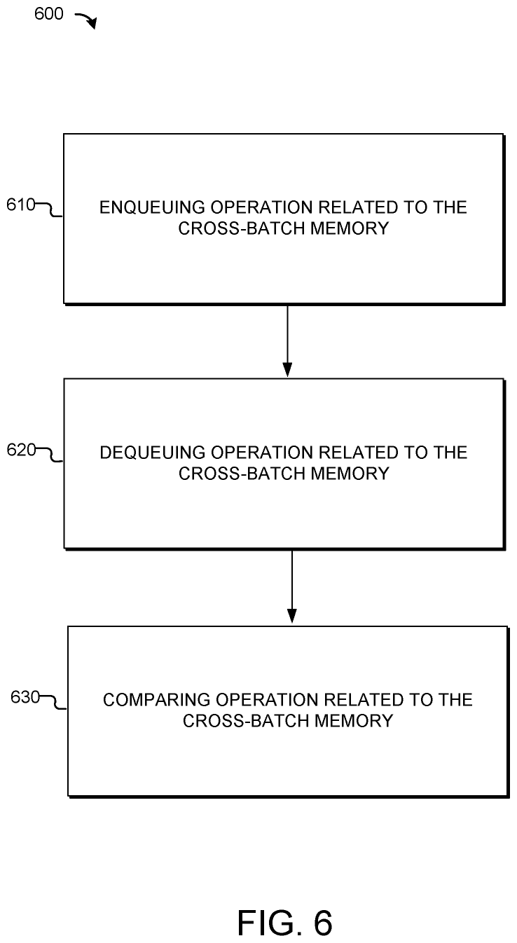

Referring now to FIG. 6, a flow diagram is provided that illustrates an exemplary process 600 of operating a cross-batch memory, e.g., performed by miner 132 in FIG. 1. In various embodiments, the XBM memory module is implemented as a queue. At each iteration, the embeddings and labels of the current mini-batch will be enqueued, and if necessary, the instances of the earliest enqueued mini-batch will be dequeued. In this way, the XBM memory module is updated with embeddings of the current mini-batch directly without requiring any additional computation. Furthermore, the whole training set can be cached in the memory module as very limited memory is required for storing the embedding features, e.g. as 512-d float vectors.

At block 610, an enqueuing operation related to the XBM is performed. In various embodiments, the XBM memory module is implemented as a queue with two ends. The process includes enqueuing, to the first end of the queue, embedding features of a first instance of a first mini-batch.

At block 620, a dequeuing operation related to the XBM is performed. In various embodiments, the process includes dequeuing, from the second end of the queue, embedding features of a second instance of a second mini-batch.

At block 630, a comparing operation related to the XBM is performed. In various embodiments, an embedding of the current mini-batch is selected as the anchor. The anchor is compared with each of the embeddings in the XBM to compute their respective similarity measures and losses. In one embodiment, the process includes computing a similarity measure between the embedding features of the first instance and embedding features of a third instance in the queue. The first instance and the third instance are from two different mini-batches. The first instance and the third instance are in different classes or with different labels. The process may further include selecting, based on the similarity measure being greater than a threshold, the first instance and the third instance as a negative pair to update the neural network.

Accordingly, we have described various aspects of the technologies for modeling and measuring compatibilities. Each block in process 500, process 600, and other processes described herein comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

It is understood that various features, sub-combinations, and modifications of the embodiments described herein are of utility and may be employed in other embodiments without reference to other features or sub-combinations. Moreover, the order and sequences of steps/blocks shown in the above example processes are not meant to limit the scope of the present disclosure in any way, and in fact, the steps/blocks may occur in a variety of different sequences within embodiments hereof. Such variations and combinations thereof are also contemplated to be within the scope of embodiments of this disclosure.

Referring to FIG. 7, an exemplary operating environment for implementing various aspects of the technologies described herein is shown and designated generally as computing device 700. Computing device 700 is but one example of a suitable computing environment and is not intended to suggest any limitation as to the scope of use of the technologies described herein. Neither should the computing device 700 be interpreted as having any dependency or requirement relating to any one or combination of components illustrated.

The technologies described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technologies described herein may be practiced in a variety of system configurations, including handheld devices, consumer electronics, general-purpose computers, and specialty computing devices, etc. Aspects of the technologies described herein may also be practiced in distributed computing environments where tasks are performed by remote processing devices that are connected through a communications network.

With continued reference to FIG. 7, computing device 700 includes a bus 710 that directly or indirectly couples the following devices: memory 720, processors 730, presentation components 740, input/output (I/O) ports 750, I/O components 760, and an illustrative power supply 770. Bus 710 may include an address bus, data bus, or a combination thereof. Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. The inventors hereof recognize that such is the nature of the art and reiterate that the diagram of FIG. 7 is merely illustrative of an exemplary computing device that can be used in connection with different aspects of the technologies described herein. The distinction is not made between such categories as “workstation,” “server,” “laptop,” “handheld device,” etc., as all are contemplated within the scope of FIG. 7 and refers to “computer” or “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technologies for storage of information such as computer-readable instructions, data structures, program modules, or other data.

Computer storage media includes RAM, ROM, EEPROM, flash memory or other memory technologies, CD-ROM, digital versatile disks (DVD) or other optical disk storage, magnetic cassettes, magnetic tape, magnetic disk storage or other magnetic storage devices. Computer storage media does not comprise a propagated data signal. A computer-readable device or a non-transitory medium in a claim herein excludes transitory signals.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 720 includes computer storage media in the form of volatile and/or nonvolatile memory. The memory 720 may be removable, non-removable, or a combination thereof. Exemplary memory includes solid-state memory, hard drives, optical-disc drives, etc. Computing device 700 includes processors 730 that read data from various entities such as bus 710, memory 720, or I/O components 760. Presentation component(s) 740 present data indications to a user or other device. Exemplary presentation components 740 include a display device, speaker, printing component, vibrating component, etc. I/O ports 750 allow computing device 700 to be logically coupled to other devices, including I/O components 760, some of which may be built-in.

In various embodiments, memory 720 includes, in particular, temporal and persistent copies of XBM logic 722. XBM logic 722 includes instructions that, when executed by processor 730, result in computing device 700 performing functions, such as, but not limited to, process 500, process 600, or other disclosed processes. In various embodiments, XBM logic 722 includes instructions that, when executed by processors 730, result in computing device 700 performing various functions associated with, but not limited to various components in connection with system 110 or its components in FIG. 1; and XBM module 230 or other modules in FIG. 2.

In some embodiments, processors 730 may be packed together with XBM logic 722. In some embodiments, processors 730 may be packaged together with XBM logic 722 to form a System in Package (SiP). In some embodiments, processors 730 can be integrated on the same die with XBM logic 722. In some embodiments, processors 730 can be integrated on the same die with XBM logic 722 to form a System on Chip (SoC).

Illustrative I/O components include a microphone, joystick, gamepad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 730 may be direct or via a coupling utilizing a serial port, parallel port, and/or other interface and/or system bus known in the art. Furthermore, the digitizer input component may be a component separate from an output component such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technologies described herein.

I/O components 760 include various GUIs, which allow users to interact with computing device 700 through graphical elements or visual indicators, such as various graphical elements illustrated in FIGS. 1-2. Interactions with a GUI usually are performed through direct manipulation of graphical elements in the GUI. Generally, such user interactions may invoke the business logic associated with respective graphical elements in the GUI. Two similar graphical elements may be associated with different functions, while two different graphical elements may be associated with similar functions. Further, the same GUI may have different presentations on different computing devices, such as based on the different graphical processing units (GPUs) or the various characteristics of the display.

Computing device 700 may include networking interface 780. The networking interface 780 includes a network interface controller (NIC) that transmits and receives data. The networking interface 780 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 780 may include a wireless terminal adapted to receive communications and media over various wireless networks. Computing device 700 may communicate with other devices via the networking interface 780 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technologies described herein has been described in relation to particular aspects, which are intended in all respects to be illustrative rather than restrictive. While the technologies described herein are susceptible to various modifications and alternative constructions, certain illustrated aspects thereof are shown in the drawings and have been described above in detail. It should be understood, however, that there is no intention to limit the technologies described herein to the specific forms disclosed, but on the contrary, the intention is to cover all modifications, alternative constructions, and equivalents falling within the spirit and scope of the technologies described herein.

### EXPERIMENTS

The following section describes the implementation details of aforementioned experiments. We use the standard settings for a fair comparison. Specifically, we adopt GoogleNet as the default backbone network if not mentioned. The weights of the backbone were pre-trained on ILSVRC 2012-CLS dataset. A 512-d fully-connected layer with l₂ normalization is added after the global pooling layer. The default embedding dimension is set as 512. For all datasets, the input images are first resized to 256×256, and then cropped to 224×224. Random crops and random flip are utilized as data augmentation during training. For testing, we only use the single-center crop to compute the embedding for each instance. In all experiments, we use Adam optimizer with 5e⁻⁴ weight decay and the PK sampler (P categories, K samples/category) to construct mini-batches.

The XBM approach is evaluated on three datasets which are widely-used on large-scale few-shot image retrieval. The Recall@k performance is reported. The training and testing protocol follow the standard setups.

Stanford Online Products (SOP) contains 120,053 online product images in 22,634 categories. There are only 2 to 10 images for each category. In one experiment, we use 59,551 images (11,318 classes) for training, and 60,502 images (11,316 classes) for testing.

In-shop Clothes Retrieval (In-shop) contains 72,712 clothing images of 7,986 classes. In one experiment, we use 3,997 classes with 25,882 images as the training set. The test set is partitioned to a query set with 14,218 images of 3,985 classes, and a gallery set having 3,985 classes with 12,612 images.

PKU VehicleID (VehicleID) contains 221,736 surveillance images of 26,267 vehicle categories, where 13,134 classes (110,178 images) are used for training. In one experiment, evaluation is conducted on a predefined small, medium and large test sets which contain 800 classes (7,332 images), 1600 classes (12,995 images) and 2400 classes (20,038 images) respectively.

We conducted an ablation study on the SOP dataset with GoogleNet to verify the effectiveness of the XBM approach.

Memory Ratio. The search space of our cross-batch hard mining can be dynamically controlled by memory ratio [symbol] . Regarding the impact of memory ratio to XBM augmented contrastive loss on three benchmarks, firstly, the XBM approach significantly outperforms the baseline (with R_{M}=0), with over 20% improvements on all three datasets using various configurations of R_{M}. Secondly, the XBM approach with a mini-batch of 16 can achieve better performance than the non-memory counterpart using 256 mini-batch, e.g. with an improvement of 71.7%→78.2% on recall@1, while the XBM approach saves GPU memory considerably.

More importantly, the XBM approach can boost the contrastive loss largely with small R_{M} (e.g. on In-shop, 52.0%→79.4% on recall@1 with R_{M}=0.01), and its performance is going to be saturated when the memory expands to a moderate size, likely because the memory with a small R_{M} (e.g. 1%) already contains thousands of embeddings to generate sufficient valid negative instances on large-scale datasets, especially fine-grained ones, such as In-shop or VehicleID. Therefore, the XBM approach can have consistent and stable performance improvements with a wide range of memory ratios.

Mini-batch size is critical to the performance of many pair-based approaches. We further investigate its impact on the memory augmented pair-based methods. The XBM approach has 3.2% performance gain by increasing a mini-batch size from 16 to 256, while the original contrastive method has a significantly larger improvement of 25.1%. Obviously, with the XBM approach, the impact of mini-batch size is reduced significantly. This indicates that the effect of mini-batch size can be strongly compensated by the XBM module, which provides a more principle solution to address the hard mining problem in DML.

TABLE 1
Retrieval results of memory augmented (‘w/M’) pair-based methods
compared with their respective baselines on three datasets.

| | | | | | | | | | | | | | VehicleID | | | |
|---|---|---|---|---|---|---|---|---|---|---|---|---|---|---|---|---|
| Recall@K | SOP | | | | In-shop | | | | | | Small | | Medium | | Large | |
| (%) | 1 | 10 | 100 | 1000 | 1 | 10 | 20 | 30 | 40 | 50 | 1 | 5 | 1 | 5 | 1 | 5 |
| Contrastive | 64 0 | 81 4 | 92 1 | 97 8 | 77 1 | 93 0 | 95 2 | 96 1 | 96 8 | 97 1 | 79 5 | 91 6 | 76 2 | 89 3 | 70 0 | 86 0 |
| Contrastive | 77.8 | 89.8 | 95.4 | 98.5 | 89.1 | 97.3 | 98.1 | 98.4 | 98.7 | 98.8 | 94.1 | 96.2 | 93.1 | 95.5 | 92.5 | 95.5 |
| w/ M | | | | | | | | | | | | | | | | |
| Triplet | 61 6 | 80 2 | 91 6 | 97 7 | 79 8 | 94 8 | 96 5 | 97 4 | 97 8 | 98 2 | 86 9 | 94 8 | 84 8 | 93 4 | 79 7 | 91 4 |
| Triplet | 74.2 | 87.4 | 94.2 | 98.0 | 82.9 | 95.7 | 96.9 | 97.4 | 97.8 | 98.0 | 93.3 | 95.8 | 92.0 | 95.0 | 91.3 | 94.8 |
| w/ M | | | | | | | | | | | | | | | | |
| MS | 69 7 | 84.2 | 93 1 | 97 9 | 85 1 | 96 7 | 97 8 | 98 3 | 98 7 | 98 8 | 91 0 | 96 1 | 89 4 | 94 8 | 86 7 | 93 8 |
| MS w/ M | 76.2 | 89.3 | 95.4 | 98.6 | 87.1 | 97.1 | 98.0 | 98.4 | 98.7 | 98.9 | 94.1 | 96.7 | 93.0 | 95.8 | 92.1 | 95.6 |

With General Pair-based DML, the XBM module can be directly applied to the GPW framework. We evaluate it with contrastive loss, triplet loss, and MS loss. As shown in Table 1, the XBM approach can improve the original DML approaches significantly and consistently on all benchmarks. Specifically, the memory module remarkably boosts the performance of contrastive loss by 64.0%→77.8% and MS loss by 69.7%→76.2%. Furthermore, with a sophisticated sampling and weighting approach, MS loss has a 16.7% recall@1 performance improvement over contrastive loss on VehicleID Large test set. Such a large gap can be simply filled by the XBM module, with a further 5.8% improvement. MS loss has a smaller improvement because it weights extremely hard negatives heavily which might be outliers, while such harmful influence is weakened by the equally weighting scheme of contrastive loss.

The results suggest that (1) both straightforward (e.g. contrastive loss) and carefully designed weighting scheme (e.g. MS loss) can be improved largely by the XBM module, and (2) with the XBM module, a simple pair-weighting method (e.g. contrastive loss) can easily outperform the state-of-the-art sophisticated methods such as MS loss by a large margin.

We further analyzed the complexity of the XBM approach on memory and computational cost. For memory cost, the XBM module [symbol] ( [symbol] (DM) and affinity matrix \tilde{S} ( [symbol] (DM) requires a negligible 0.2 GB GPU memory for caching the whole training set (Table 2). For computational complexity, the cost of \tilde{S} ( [symbol] (mDM) increases linearly with memory size M. With a GPU implementation, it takes a reasonable 34% amount of extra training time regarding the forward and backward procedure.

It is also worth noting that the XBM module does not act in the inference phase. It only requires about one hour extra training time and 0.2 GB memory, to achieve a surprising 13.5% performance gain by using a single GPU. Moreover, the XBM approach can be scalable to an extremely large-scale dataset, e.g. with 1 billion samples, since the XBM module can generate a rich set of valid negatives with a small-memory-ratio XBM.

Regarding quantitative and qualitative results, we compare the XBM augmented contrastive loss with the state-of-the-art DML methods on three benchmarks on image retrieval. Even though the XBM approach can achieve better performance with a larger mini-batch size, a moderate mini-batch size is used, which can be implemented with a single GPU with ResNet50. Since the backbone architecture and embedding dimension can affect the recall metric, we list the results of our method with various configurations for fair comparison in Tables 3, 4, and 5 below.

TABLE 3
Recall@K(%) performance on SOP. ‘G’, ‘B’, and ‘R’ denotes applying GoogleNet, InceptionBN,
and ResNet50 as backbone respectively, and the superscript is embedding size.

| Recall@K (%) | | 1 | 10 | 100 | 1000 |
|---|---|---|---|---|---|
| HDC [46] | G³⁸⁴ | 69.5 | 84.4 | 92.8 | 97.7 |
| A-BIER [25] | G⁵¹² | 74.2 | 86.9 | 94.0 | 97.8 |
| ABE [15] | G⁵¹² | 76.3 | 88.4 | 94.8 | 98.2 |
| SM [33] | G⁵¹² | 75.2 | 87.5 | 93.7 | 97.4 |
| Clustering [32] | B⁶⁴ | 67.0 | 83.7 | 93.2 | — |
| ProxyNCA [22] | B⁶⁴ | 73.7 | — | — | — |
| HTL [6] | B⁵¹² | 74.8 | 88.3 | 94.8 | 98.4 |
| MS [38] | B⁵¹² | 78.2 | 90.5 | 96.0 | 98.7 |
| SoftTriple [26] | B⁵¹² | 78.6 | 86.6 | 91.8 | 95.4 |
| Margin [41] | R¹²⁸ | 72.7 | 86.2 | 93.8 | 98.0 |
| Divide [29] | R¹²⁸ | 75.9 | 88.4 | 94.9 | 98.1 |
| FastAP [2] | R¹²⁸ | 73.8 | 88.0 | 94.9 | 98.3 |
| MIC [27] | R¹²⁸ | 77.2 | 89.4 | 95.6 | — |
| Cont. w/ M | G⁵¹² | 77.4 | 89.6 | 95.4 | 98.4 |
| Cont. w/ M | B⁵¹² | 79.5 | 90.8 | 96.1 | 98.7 |
| Cont. w/ M | R¹²⁸ | 80.6 | 91.6 | 96.2 | 98.7 |

TABLE 4
Recall@K (%) performance on In-Shop.

| Recall@K | | | | | | | |
|---|---|---|---|---|---|---|---|
| (%) | | 1 | 10 | 20 | 30 | 40 | 50 |
| HDC [46] | G³⁸⁴ | 62.1 | 84.9 | 89.0 | 91.2 | 92.3 | 93.1 |
| A-BIER [25] | G⁵¹² | 83.1 | 95.1 | 96.9 | 97.5 | 97.8 | 98.0 |
| ABE [15] | G⁵¹² | 87.3 | 96.7 | 97.9 | 98.2 | 98.5 | 98.7 |
| HTL [6] | B⁵¹² | 80.9 | 94.3 | 95.8 | 97.2 | 97.4 | 97.8 |
| MS [38] | B⁵¹² | 89.7 | 97.9 | 98.5 | 98.9 | 99.1 | 99.2 |
| Divide [29] | R¹²⁸ | 85.7 | 95.5 | 96.9 | 97.5 | — | 98.0 |
| MIC [27] | R¹²⁸ | 88.2 | 97.0 | — | 98.0 | — | 98.8 |
| FastAP [2] | R⁵¹² | 90.9 | 97.7 | 98.5 | 98.8 | 98.9 | 99.1 |
| Cont. w/ M | G⁵¹² | 89.4 | 97.5 | 98.3 | 98.6 | 98.7 | 98.9 |
| Cont. w/ M | B⁵¹² | 89.9 | 97.6 | 98.4 | 98.6 | 98.8 | 98.9 |
| Cont. w/ M | R¹²⁸ | 91.3 | 97.8 | 98.4 | 98.7 | 99.0 | 99.1 |

TABLE 5
Recall@K (%) performance on VehicleID.

| | | Small | | Medium | | Large | |
|---|---|---|---|---|---|---|---|
| Method | | 1 | 5 | 1 | 5 | 1 | 5 |
| GS-TRS [5] | | 75.0 | 83.0 | 74.1 | 82.6 | 73.2 | 81.9 |
| BIER [24] | G⁵¹² | 82.6 | 90.6 | 79.3 | 88.3 | 76.0 | 86.4 |
| A-BIER [25] | G⁵¹² | 86.3 | 92.7 | 83.3 | 88.7 | 81.9 | 88.7 |
| VANet [4] | G²⁰⁴⁸ | 83.3 | 95.9 | 81.1 | 94.7 | 77.2 | 92.9 |
| MS [38] | B⁵¹² | 91.0 | 96.1 | 89.4 | 94.8 | 86.7 | 93.8 |
| Divide [29] | R¹²⁸ | 87.7 | 92.9 | 85.7 | 90.4 | 82.9 | 90.2 |
| MIC [27] | R¹²⁸ | 86.9 | 93.4 | — | — | 82.0 | 91.0 |
| FastAP [2] | R⁵¹² | 91.9 | 96.8 | 90.6 | 95.9 | 87.5 | 95.1 |
| Cont w/ M | G⁵¹² | 94.0 | 96.3 | 93.2 | 95.4 | 92.5 | 95.5 |
| Cont. w/ M | B⁵¹² | 94.6 | 96.9 | 93.4 | 96.0 | 93.0 | 96.1 |
| Cont. w/ M | R¹²⁸ | 94.7 | 96.8 | 93.7 | 95.8 | 93.0 | 95.8 |

With the XBM module, a contrastive loss can surpass the state-of-the-art methods on all datasets by a large margin. On SOP, the XBM approach with R¹²⁸ outperforms the current state-of-the-art method: MIC by 77.2%→80.6%. On In-shop, the XBM approach with R¹²⁸ achieves even higher performance than FastAP with R512, and improves by 88.2%→91.3% compared to MIC. On VehicleID, the XBM approach outperforms existing approaches considerably. For example, on the large test dataset, by using the same G512, the XBM approach improves the R@1 of recent A-BIER largely by 81.9%→92.5%. With R¹²⁸, the XBM approach surpasses the best results by 87%→93%, which is obtained by FastAP using R⁵¹².

Experiments show that the XBM approach promotes the learning of a more discriminative encoder. For example, the experimental results show that the XBM approach is aware of specific characteristics of the query product and retrieves the correct images based on those specific characteristics of the query product.

### EXAMPLES

Lastly, by way of example, and not limitation, the following examples are provided to illustrate various embodiments, in accordance with at least one aspect of the disclosed technologies. Examples comprise a method, a computer system configured to perform the method, or a computer storage device storing computer-usable instructions that cause a computer system to perform the method.

Example 1 includes operations for storing embedding features of respective instances in a plurality of mini-batches in a cross-batch memory, wherein a neural network is updated after processing each of the plurality of mini-batches; identifying, based on the embedding features stored in the cross-batch memory, one or more negative pairs of instances from the plurality of mini-batches; and updating the neural network based on the one or more negative pairs of instances.

Example 2 may include the subject matter of one or more examples in this disclosure, and further includes operations for measuring a difference of embedding features for the same instance at different epochs; and determining, based on the difference being less than a threshold, a number of epochs to warm up the neural network before identifying the one or more negative pairs of instances from the plurality of mini-batches.

Example 3 may include the subject matter of one or more examples in this disclosure, wherein the cross-batch memory comprises a queue with a first end and a second end, and further includes operations for enqueuing, to the first end of the queue, embedding features of a first instance of a first mini-batch.

Example 4 may include the subject matter of one or more examples in this disclosure, and further includes operations for dequeuing, from the second end of the queue, embedding features of a second instance of a second mini-batch.

Example 5 may include the subject matter of one or more examples in this disclosure, and further includes operations for computing respective similarity measures between the embedding features of the first instance and embedding features of each instance in the queue, and providing the respective similarity measures and corresponding pairs of instances to minimize a loss function of the neural network.

Example 6 may include the subject matter of one or more examples in this disclosure, and further includes operations for computing a similarity measure between the embedding features of the first instance and embedding features of a third instance in the queue, wherein the first instance and the third instance are from two different mini-batches and with two different labels; and selecting, based on the similarity measure being greater than a threshold, the first instance and the third instance as a negative pair to train the neural network.

Example 7 may include the subject matter of one or more examples in this disclosure, and further includes operations for determining a pair-based loss between the first instance and the third instance; and conducting a backpropagation operation based on the pair-based loss.

Example 8 may include the subject matter of one or more examples in this disclosure, and further includes operations for recognizing, based on the neural network, a product.

Example 9 may include the subject matter of one or more examples in this disclosure, and further includes operations for performing, based on the neural network, an image retrieval task, a face recognition task, or another type of computer vision task.

Example 10 includes operations of enqueuing, to a first end of a cross-batch memory, embedding features of a first instance of a first mini-batch; dequeuing, from a second end of the cross-batch memory, embedding features of a second instance of a second mini-batch; forming a cross-batch pair between the first instance and a third instance in the cross-batch memory, wherein the first instance and the third instance are from two different mini-batches; and updating a neural network based on the cross-batch pair.

Example 11 may include the subject matter of one or more examples in this disclosure, and further includes operations for computing a similarity measure between the embedding features of the first instance and embedding features of the third instance in the cross-batch memory; and minimizing, based on the similarity measure, a loss function of the neural network.

Example 12 may include the subject matter of one or more examples in this disclosure, and further includes operations for measuring a difference of embedding features for the same instance at two different epochs, wherein the two different epochs has a plurality of intermediate epochs; and activating, based on the difference being less than a threshold, the cross-batch memory to augment a pair-based training method to train the neural network.

Example 13 may include the subject matter of one or more examples in this disclosure, and further includes operations for capturing, via the cross-batch pair, cross-batch information between the two different mini-batches to train the neural network.

Example 14 may include the subject matter of one or more examples in this disclosure, and further includes operations for computing a pair-based loss between the first instance and each of a plurality of instances in the cross-batch memory to collect informative negative pairs for a pair-based model to train the neural network.

Example 15 may include the subject matter of one or more examples in this disclosure, and further includes operations for forming a first plurality of intra-batch pairs by pairing the first instance with a first plurality of instances in the cross-batch memory, wherein the first instance and the first plurality of instances belong to the same mini-batch.

Example 16 may include the subject matter of one or more examples in this disclosure, and further includes operations for forming a second plurality of inter-batch pairs by pairing the first instance with a second plurality of instances in the cross-batch memory, wherein the first instance and the second plurality of instances belong to different mini-batches.

Example 17 may include the subject matter of one or more examples in this disclosure, and further includes operations for training the neural network with both intra-batch pairs and inter-batch pairs in a pair-based training model.

Example 18 may include the subject matter of one or more examples in this disclosure, and further includes operations for retrieving, based on the neural network, one or more images according to a search image.

Example 19 may include the subject matter of one or more examples in this disclosure, and further includes operations for matching, based on the neural network, two face images.

Example 20 includes a processor; a neural network and a cross-batch memory, operatively coupled to the processor, configured for a cross-batch pair formation for a pair-based model to train the neural network; and instructions, wherein the instructions, when executed by the processor, cause the processor to form a cross-batch pair between a first instance in a current mini-batch of a current training epoch and a second instance stored in the cross-batch memory, wherein the second instance is from a previous mini-batch of the current training epoch.

Example 21 may include the subject matter of one or more examples in this disclosure, and further cause a processor to provide, based on a pair-based loss between the cross-batch pair, the cross-batch pair as a negative pair for a pair-based model to train the neural network; and perform, based on the neural network, a computer vision task.

Example 22 may include the subject matter of one or more examples in this disclosure, wherein the cross-batch memory comprises a queue with a first end and a second end, and further cause the processor to enqueue, to the first end of the cross-batch memory, embedding features of the first instance; or dequeue, from the second end of the cross-batch memory, embedding features of a third instance.

Example 23 may include the subject matter of one or more examples in this disclosure, and further cause a processor to determine a similarity measure between the embedding features of the first instance and embedding features of the second instance; and determine, based on the similarity measure, the pair-based loss between the cross-batch pair.

Example 24 may include the subject matter of one or more examples in this disclosure, wherein the pair-based loss comprises a contrastive loss.

Example 25 may include the subject matter of one or more examples in this disclosure, wherein the computer vision task comprises a product recognition task, an image retrieval task, or a face recognition task.

What is claimed is:

1. A computer-implemented method for embedding learning, comprising:
storing embedding features of respective instances in different mini-batches in a cross-batch memory;
identifying, based on the embedding features stored in the cross-batch memory, one or more negative pairs of instances in the different mini-batches; and
updating a neural network based on the one or more negative pairs of instances.

2. The method of claim 1, further comprising:
measuring a difference of embedding features for a same instance at different epochs; and
determining, based on the difference of the embedding features for the same instance being less than a threshold, a number of epochs to warm up the neural network before identifying the one or more negative pairs of instances.

3. The method of claim 1, wherein the cross-batch memory comprises a queue with a first end and a second end, and storing embedding features of respective instances comprises:
enqueuing, to the first end of the queue, embedding features of a first instance of a first mini-batch of the different mini-batches.

4. The method of claim 3, further comprising:
dequeuing, from the second end of the queue, embedding features of a second instance of a second mini-batch of the different mini-batches.

5. The method of claim 3, further comprising:
computing respective similarity measures between the embedding features of the first instance and embedding features of each instance in the queue; and
using the respective similarity measures and corresponding pairs of instances to minimize a loss function of the neural network.

6. The method of claim 3, further comprising:
computing a similarity measure between the embedding features of the first instance and embedding features of a third instance in the queue, wherein the first instance and the third instance are from two different mini-batches, the first instance and the third instance are in different classes; and
selecting, based on the similarity measure being greater than a threshold, the first instance and the third instance as a negative pair to update the neural network.

7. The method of claim 6, further comprising:
determining a pair-based loss between the first instance and the third instance; and
conducting a backpropagation operation based on the pair-based loss.

8. The method of claim 1, further comprising:
performing, based on the neural network, a product recognition task, an image retrieval task, a face recognition task, or another type of computer vision task.

9. A computer-readable storage device encoded with instructions that, when executed, cause one or more processors of a computing system to perform operations of embedding learning, comprising:
enqueuing, to a first end of a cross-batch memory, embedding features of a first instance of a first mini-batch;
dequeuing, from a second end of the cross-batch memory, embedding features of a second instance of a second mini-batch;
forming a cross-batch pair between the first instance and a third instance in the cross-batch memory, wherein the first instance and the third instance are from two different mini-batches; and
updating a neural network based on the cross-batch pair.

10. The computer-readable storage device of claim 9, wherein the instructions that, when executed, further cause the one or more processors to perform operations comprising:
computing a similarity measure between the embedding features of the first instance and embedding features of the third instance in the cross-batch memory; and
minimizing, based on the similarity measure, a loss function of the neural network.

11. The computer-readable storage device of claim 9, wherein the instructions that, when executed, further cause the one or more processors to perform operations comprising:
measuring a difference of embedding features for a same instance at two different epochs, wherein the two different epochs have a plurality of intermediate epochs; and
activating, based on the difference being less than a threshold, the cross-batch memory to augment a pair-based training method to train the neural network.

12. The computer-readable storage device of claim 9, wherein the instructions that, when executed, further cause the one or more processors to perform operations comprising:
capturing, via the cross-batch pair, cross-batch information between the two different mini-batches to train the neural network.

13. The computer-readable storage device of claim 9, wherein the instructions that, when executed, further cause the one or more processors to perform operations comprising:
computing a pair-based loss between the first instance and each of a plurality of instances in the cross-batch memory to collect informative negative pairs for a pair-based model to train the neural network.

14. The computer-readable storage device of claim 9, wherein the instructions that, when executed, further cause the one or more processors to perform operations comprising:
forming a first plurality of intra-batch pairs by pairing the first instance with a first plurality of instances in the cross-batch memory, wherein the first instance and the first plurality of instances belong to a same mini-batch;
forming a second plurality of inter-batch pairs by pairing the first instance with a second plurality of instances in the cross-batch memory, wherein the first instance and the second plurality of instances belong to different mini-batches; and
providing the first plurality of intra-batch pairs and the second plurality of inter-batch pairs to a pair-based model to train the neural network.

15. The computer-readable storage device of claim 9, wherein the instructions that, when executed, further cause the one or more processors to perform operations comprising:
performing, based on the neural network, a product recognition task, an image retrieval task, a face recognition task, or another type of computer vision task.

16. A system for embedding learning, comprising:
a processor;
a neural network and a cross-batch memory, operatively coupled to the processor, configured for a cross-batch pair formation for a pair-based model to train the neural network; and
instructions, wherein the instructions, when executed by the processor, cause the processor to:
form a cross-batch pair between a first instance in a current mini-batch of a current training epoch and a second instance stored in the cross-batch memory, wherein the second instance is from a previous mini-batch of the current training epoch;
provide, based on a pair-based loss between the cross-batch pair, the cross-batch pair as a negative pair for the pair-based model to train the neural network; and
conduct, based on the neural network, a computer vision task.

17. The system of claim 16, wherein the cross-batch memory comprises a queue with a first end and a second end, when the instructions executed by the processor, further cause the processor to:
enqueue, to the first end of the cross-batch memory, embedding features of the first instance; and
dequeue, from the second end of the cross-batch memory, embedding features of a third instance.

18. The system of claim 16, wherein the instructions, when executed by the processor, further cause the processor to:
determine a similarity measure between the embedding features of the first instance and embedding features of the second instance; and
determine, based on the similarity measure, the pair-based loss between the cross-batch pair.

19. The system of claim 16, wherein the pair-based loss comprises a contrastive loss.

20. The system of claim 16, wherein the computer vision task comprises a product recognition task, an image retrieval task, or a face recognition task.
